(19) United States
(12) Patent Application Publication
(10) Pub. No.: US 2026/0043952 A1
(43) Pub. Date: Feb. 12, 2026

(54) IMAGING-BASED INTELLIGENT SPECTROMETER ON PLASMONIC 2D CHIP AND METHOD

(71) Applicant: KING ABDULLAH UNIVERSITY OF SCIENCE AND TECHNOLOGY, Thuwal (SA)

(72) Inventor: Qiaoqiang GAN, East Amherst, NY (US)

(21) Appl. No.: 19/101,057

(22) PCT Filed: Aug. 2, 2023
(86) PCT No.: PCT/IB2023/057838

§ 371 Date: Feb. 4, 2025

Related U.S. Application Data
(60) Provisional application No. 63/395,710, filed on Aug. 5, 2022.

(51) Int. Cl. G02B 5/18; G01J 3/02; G01J 3/18; G01J 3/28; G01J 3/46; G01J 4/04

(52) U.S. Cl. CPC G02B 5/1809; G01J 3/0259; G01J 3/18; G01J 3/28; G01J 3/46; G01J 4/04; G01J 2003/1847; G01J 2003/284; G02B 2207/101

(57) ABSTRACT

A spectrometer on a chip system includes a plasmonic chip configured to have first plural grooves and second plural grooves, formed at a non-zero angle relative to the first plural grooves, wherein the first and second plural grooves generate plasmon resonance patterns when illuminated with an incident light beam, a light detector configured to receive a transmitted light beam or a reflected light beam, and to transform the transmitted light beam or the reflected light beam into an electronic reflected image, RI, and a processor that hosts a deep learning application configured to receive the electronic reflected image RI and generate a spectrum of the reflected light.

### CROSS-REFERENCE TO RELATED APPLICATIONS

This application claims priority to U.S. Provisional Patent Application No. 63/395,710, filed on Aug. 5, 2022, entitled “IMAGING-BASED INTELLIGENT SPECTROMETER ON A PLASMONIC,” the disclosure of which is incorporated herein by reference in its entirety.

### BACKGROUND OF THE INVENTION

### Technical Field

Embodiments of the subject matter disclosed herein generally relate to a plasmonic nanostructure-based chip that is designed for determining spectroscopic and polarimetric information of an illumination spectrum, and more particularly, to a system that removes the need of moving polarizers and optical elements required in conventional polarimetric spectroscopic systems.

### Discussion of the Background

Optical spectroscopy is one of the most widely used techniques for fundamental research as well as industrial processes. The state of the art benchtop systems, which produce accurate and precise results in terms of spectroscopic and polarimetric information, are usually bulky, expensive, and mainly designed for laboratory and industrial spectroscopic analysis. In recent years, researchers and major industrial players have shifted focus toward developing miniaturized, portable, and inexpensive spectrometer systems, which can enable many emerging applications for on-site, real-time, and in-situ spectroscopic analysis [1]. For instance, 195 colloidal quantum dot filters with different optical transmission properties were placed on top of a smartphone camera chip [2]. By processing the large set of sensor readings, this chip-scale system can reconstruct the spectral features of incident light in the visible to near-infrared (IR) spectral range. Another pioneering work employed a single compositionally engineered nanowire as the key active element of a new ultra-compact spectrometer chip [3]. Combined with extended post-data processing algorithms, the spectral response of the compact chip can be used to reconstruct the incident spectral information.

Over the past decade, various photonic crystal slab filters, plasmonic and metasurface filters were also proposed to be integrated with CMOS camera chips [4-6]. It was believed that these thin film optical filters can be integrated with each pixel of the camera chip and enable various spectroscopy analysis functionalities, including miniaturized spectrometers [7], polarimetric sensing/imaging [8], and compressing spectroscopic sensing [9]. However, due to the over-simplified optical design and mechanical limit of compact architectures, the actual spectral identification performance of the traditional miniaturized spectrometer systems is usually much lower than their benchtop counterparts.

A strategy to address these limitations is to implement deep learning (DL) in the data processing steps in photonic methodology [10-12]. DL offers much potential to the miniaturization of modern technologies for several reasons. First, it has the ability to exploit information from data that may be indiscernible by traditional methods. Second, its flexibility in design makes it compatible with nanophotonic platforms, such as metasurfaces and plasmonic nanostructures [13]. Third, DL algorithms can be applicable to various functions, such as spectral reconstruction [14], high-resolution imaging [15], classification [16, 17], noise suppression [18], and inverse design of photonic structures [19]. However, DL algorithms in these pioneering efforts are often limited to a single function (see [14, 16-18]). This is attributed to the data that are available to train and test these models, which are actually limited by the information contained by the data collected from optical systems. For example, the authors in used a spectral encoding chip composed of 252 plasmonic nanohole arrays to train a DL reconstruction algorithm. Due to the simplistic design of the plasmonic arrays, the encoding chip was only able to extract information about the spectral peaks of the incident light. Thus, other features like polarization were rendered as lost information, limiting the feasibility of the system in spectroscopic applications.

These limitations of the existing chips present a challenge in expanding the capabilities of compact systems enabled by DL. Under these scenarios, physical data with multi-dimensional features may be able to enable the development of more powerful DL-based systems. Consequently, there is a need for engineering the physical layer (i.e., optical systems and plasmonic/metamaterial nanostructures [21]) to provide more distinguishable training and testing data for DL algorithms.

### SUMMARY OF THE INVENTION

According to an embodiment, there is a spectrometer on a chip system that includes a plasmonic chip configured to have first plural grooves and second plural grooves, formed at a non-zero angle relative to the first plural grooves, wherein the first and second plural grooves generate plasmon resonance patterns when illuminated with an incident light beam, a light detector configured to receive a transmitted light beam or a reflected light beam, and to transform the transmitted light beam or the reflected light beam into an electronic reflected image, RI, and a processor that hosts a deep learning application configured to receive the electronic reflected image RI and generate a spectrum of the reflected light.

According to another embodiment, there is a plasmonic chip that includes a layer of metal having first plural grooves, and second plural grooves, formed at a non-zero angle relative to the first plural grooves. The first and second plural grooves generate plasmon resonance patterns when illuminated with an incident light beam.

According to yet another embodiment, there is a method for determining a spectrum and polarization of a light, and the method includes receiving an incident light beam at a plasmonic chip, which is configured to have first plural grooves and second plural grooves, which are formed at a non-zero angle relative to the first plural grooves, wherein the first and second plural grooves generate plasmon resonance patterns when illuminated with the incident light beam, generating a transmitted light beam or a reflected light beam that includes the plasmon resonance patterns, receiving the transmitted light beam or the reflected light beam at a light detector, which is configured to transform the transmitted light beam or the reflected light beam into an electronic reflected image, RI, and processing, with a processor that hosts a deep learning application, the electronic reflected image RI and simultaneously generating a spectrum of the reflected light beam and associated polarization.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a one-dimensional, 1D, plasmonic chip with chirped gratings;

FIG. 2 is a schematic diagram of a spectrometer on a chip system configured to observe “rainbow trapping” patterns;

FIG. 3 illustrates spectral lineshapes corresponding to the rainbow trapping patterns detected by the system of FIG. 2;

FIG. 4 schematically illustrates the rainbow trapping patterns and an artificial intelligence reconstructed spectrum;

FIG. 5 schematically illustrates a layer configuration of a deep learning based application that it trained to reconstruct the spectrum of a light detected by the chip;

FIG. 6A shows the deep-learning reconstructed spectrum for a two peak wavelength combination and FIG. 6B shows the deep-learning reconstructed spectrum for a three peak wavelength combination, for the chip of FIG. 1;

FIGS. 7A and 7B show the deep-learning reconstructed spectrum and the measured spectra when using the chip of FIG. 1;

FIG. 8A is a schematic diagram of a two-dimensional, 2D, plasmonic chip with chirped gratings, FIG. 8B shows the chip of FIG. 8A configured to work in a reflection mode, and FIG. 8C shows the chip of FIG. 8A configured to work in a transmission mode;

FIGS. 9A to 9D illustrate reflection images of the 2D chip under illumination with various wavelengths;

FIG. 10A illustrate the reconstructed spectrum for vertically polarized light with various peaks and FIG. 10B illustrate the reconstructed spectrum for horizontally polarized light with the same peaks, when the chip of FIG. 8A is used;

FIG. 11A schematically illustrates a spectrometer on a chip system that uses the chip of FIG. 8B, and FIG. 11B schematically illustrates a spectrometer on a chip system that uses the chip of FIG. 8C;

FIG. 12A is a table that illustrates the training and testing data parameters for double-peak illumination for optical rotatory dispersion sensing and FIG. 12B is a table that illustrates the training and testing data parameters for triple-peak illumination for optical rotatory dispersion sensing, when using the system of FIG. 11A;

FIGS. 13A and 13B illustrate predictions of the optical rotation introduced by various glucose solutions for double and triple-peak illumination, respectively; and

FIG. 14 is a flow chart of a method for determining the spectro-polarimetric features of a sample with the system of FIG. 11A or FIG. 11B.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to a 2D plasmonic chip for rapid, accurate dual-functional spectroscopic sensing. However, the embodiments to be discussed next are not limited to a 2D chip, but may be applied to other dimension chips and/or for other sensing.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel, intelligent, on-chip spectrometer is introduced by integrating an on-chip rainbow trapping phenomenon with a compact optical imaging system. “Rainbow trapping” is understood herein as a scheme for localized storage of broadband electromagnetic radiation in metamaterials and/or plasmonic heterostructures (i.e., the chip). The results associated with this novel chip show that the plasmonic chip can distinguish between different illumination peaks across the visible spectrum (470-740 nm). Making full use of its wavelength-sensitive structure, the chip can illustrate varying plasmon resonance patterns based on the peaks of the illumination spectrum. By expanding the chip to its 2D structure, the increased complexity of the resonance patterns offers an added level of information in terms of the incident light polarization. By training the DL algorithms with images of the spatial and intensity distributions of the on-chip resonance patterns, spectroscopic and polarimetric analysis is achieved within the same system, respectively. Using a chiral substance, for example, glucose, which introduces optical rotation to the transmitting light, the feasibility of the novel spectrometer is demonstrated in the sensing of optical rotatory dispersion (ORD), a polarization-specific feature that is useful for detection and quantification of chiral substances. Analysis performed by the DL application shows that the algorithm is capable of accurately predicting the optical rotation introduced by glucose based on the resonance pattern of the plasmonic chip. This performance is preserved even when analyzing resonance patterns under illumination of multiple peaks. This image-based spectrometer enabled by DL is capable of performing both spectroscopic and polarimetric analysis by utilizing a single image of the nanophotonic platform. As such, the novel system is empowered with a far-reaching impact on spectro-polarimetric sensing applications.

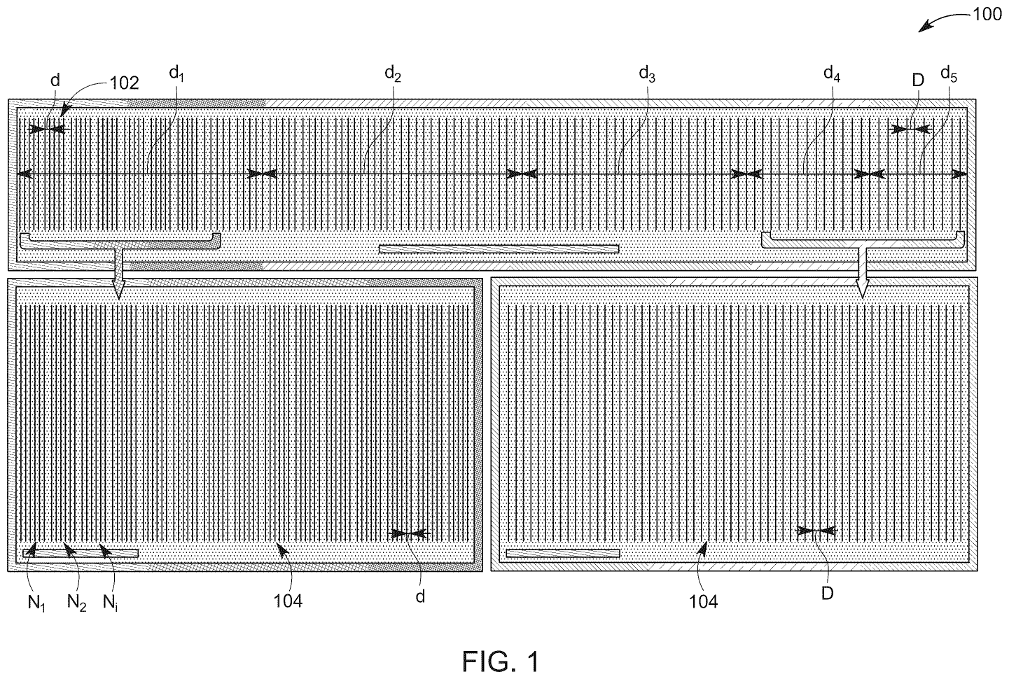

Before discussing the novel 2D plasmonic chip, a 1D plasmonic chip that uses the rainbow trapping effect is discussed for introducing the basic concepts. An on-chip spectrometer system 100 is illustrated in FIG. 1. The chip 100 is made of a conductive material 102 (e.g., silver but other conductors are also possible), which is shaped as a rectangle. Plural grooves 104 are formed in the surface of the material 102 to form a grating. A first group N1 of grooves 104 has a separation distance D1 between adjacent grooves, while an adjacent group N2 of grooves 104 has a separation distance D2. N1 and N2 may be equal or different and they may have any natural, non-zero, value. The distance D2 is larger than the distance D1. The same is true for the other groups Ni, i.e., the distance between adjacent grooves increases from one group to the next, so that a chirped grating is achieved. FIG. 1 shows 5 groups of grooves, each group having a total spatial footprint L1 to L5.

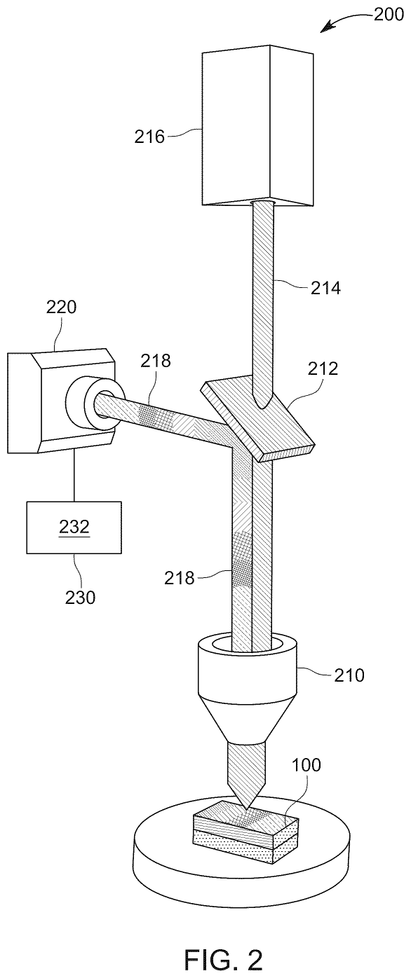

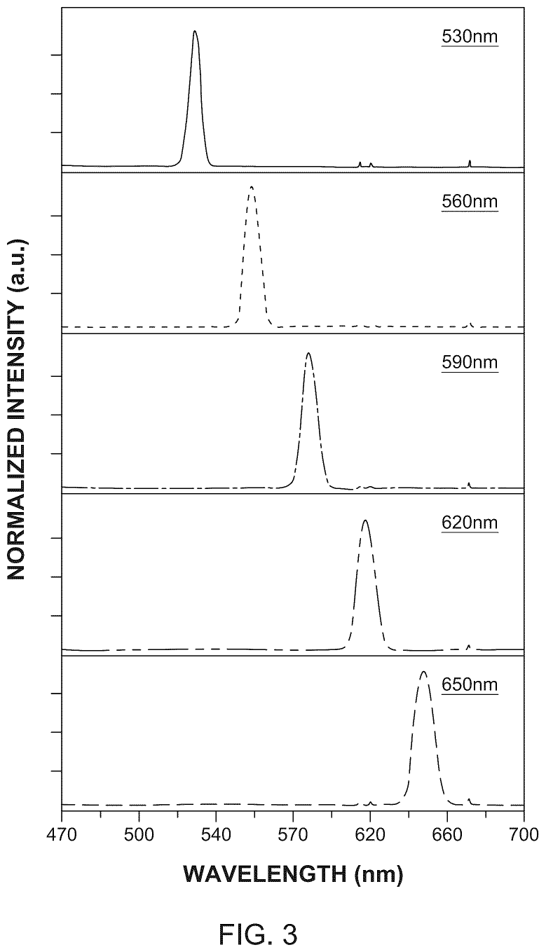

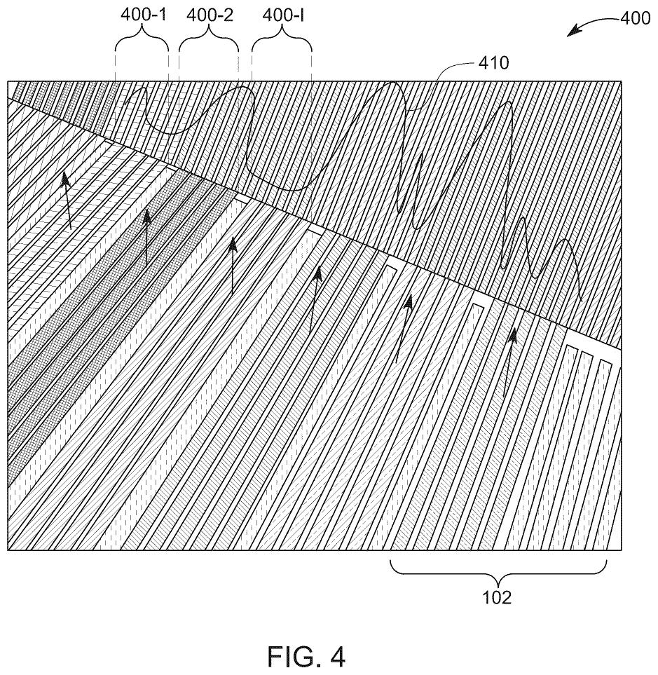

Wavelength splitting functionality can be realized by the plasmonic chirped grating. The geometry of the chirped grating makes the incident wavelengths to have a maximum at different locations along the chip, which appears as a rainbow (see FIG. 4), from which the name of this phenomenon. In other words, as the geometry of the surface of the material 102 changes gradually, it results in the spatial tuning of the local plasmonic resonances (i.e., so-called trapped “rainbow” storage of light). As shown in FIG. 1, this embodiment uses focus-ion milling to fabricate a chirped grating on a 300 nm thick Ag film. FIG. 1 also shows each group Ni including 6-groove units with a varying distance (period) changing from 244 to 764 nm. The width of the grooves 104 is 200 nm. A depth of the grooves can have a value between 1 and 50 nm. Under the normal incidence of a white light, one can employ a simple reflection microscope system 200, as shown in FIG. 2, to observe “rainbow” color images, as illustrated in FIG. 3. due to the plasmonic resonances supported by these gratings. Note that system 200 includes the plasmonic chip 100, an objective lens 210 located above the plasmonic chip 100, a beam splitter 212, which is configured to allow an incident light 214, from a light source 216, to reach the chip 100, and also to deviate a reflecting light beam 218 to a light detector 220, for analysis. By introducing narrowband incident light 214 to illuminate the chip 100, one can distinguish the different wavelengths from their spatial patterns (see the spectral line shapes of varying wavelengths in FIG. 3). Based on these spatial pattern images, a one-to-one correspondence of the resonant pattern can be established with the incident wavelength, indicating the foundation of an on-chip spectrometer. Thus, a spatial correspondence for arbitrary spectral features can be investigated using DL-assisted data processing and reconstruction methods, so that the wavelength splitting functionality can enable an intelligent and miniaturized spectrometer platform for optical integration. Note that the chip 100 may also be used in an existing optical microscope as a microscope slide.

Accurate spectrum reconstruction is one goal of the miniaturized spectrometer systems. However, this goal posed major challenges in previously reported works. For instance, in the recently reported single nanowire spectrometer, the spectral pattern was measured for each of the n photodetector units. A linear equation is formed and solved based on the spectral pattern and the pre-determined spectral response function, whose solution gives the reconstructed spectrum. However, as with all linear methods, the reconstructed target spectrum can be largely distorted when there is measurement noise and/or errors in the pattern image. Despite a number of methods to address the issue of ill-posedness, such as adaptive Tikhonov regularization and iterative algorithms, such as compressed sensing, these methods heavily rely on the accuracy of the estimated spectral response function, which is typically not guaranteed. In addition, regularization, which involves tedious parameter tuning, can introduce bias to the reconstructed spectrum. The computational complexity can be high when solving a large number of equations. Due to the above limitations of the existing spectra reconstruction methods, there are visible deviations from the actual spectrum for the existing miniaturized spectrometers.

To overcome these problems, the chip 100 is coupled with a DL application so that a DL-based method is used to address all of the above-mentioned challenges. Specifically, in one embodiment, the intelligent rainbow plasmonic spectrometer 200 is configured to be driven by a DL application 232, which is hosted by a processor 230, which may also be used to control the detector 220, and the light source 216. The spectrometer 200 is capable of predicting the unknown incident light 214's spectrum from the measured resonance pattern image using a deep neural network, bypassing the traditional linear model using response functions.

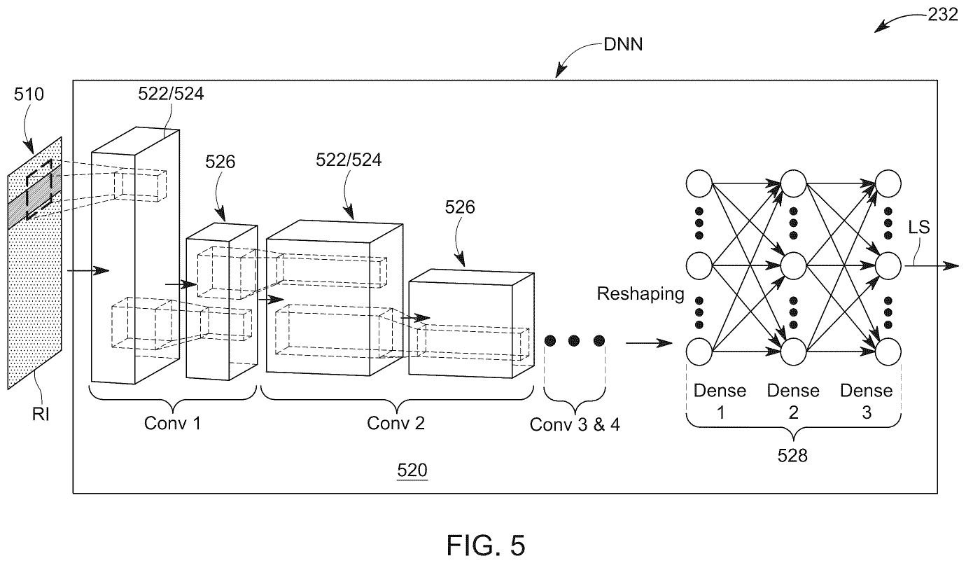

The intelligent spectrometer 200 generates a spatial pattern (image 400 in FIG. 4, having various colors 400-1) due to the plasmonic chip 100, as the wavelength associated with the incoming light beam 214 is incident to the plasmonic chip. The spatial pattern 400, which is the reflection image of the miniaturized rainbow spectrometer 100 captured through reflection by the detector 220, is a unique fingerprint of the incident light 214, and thus, it is used as the input to the neural network of the DL application 232. By using DL 232, it is desired to exploit and generalize the intricate relationship from the spatial pattern 400 to the incident wave 214 for a specific plasmonic chirped grating 100, such that the pretrained neural network 232 is able to accurately predict the intensity, wavelength, and polarization (spectra 410) of the incident light 214. The architecture of the DL application 232 is shown in FIG. 5. As shown in this figure, the deep neural network (DNN) includes a set of input neurons 510 that are inter-connected to a number of neurons in hidden layers 520. Information propagates forward via a linear operation such as convolutions 522 with an activation function, for example, a rectified linear unit (ReLU) 524, followed by a nonlinear pooling operation in a pooling layer 526. Several convolutional layers and pooling layers 522/524 are stacked and the final output is obtained by flattening the output of the last pooling layer via dense (fully connected) layers 528. In other words, each reflection image RI (more precisely, the electronic signal associated with the reflected light 218 recorded by the light detector 220), is used as neural network input, and is associated with a light spectrum LS as a prediction output. Before using the neural network, the synaptic strengths between each layer (i.e., the weights of the linear operation) need to be adequately trained via a back-propagation algorithm, such as gradient descent or adaptive optimizer. Other algorithms may be used.

During training, a fiber-coupled LED light is employed as the incident light with the option to combine different wavelengths. In one embodiment, the inventor first combined pairs of two and three arbitrary wavelengths (e.g., 525+660 nm and 435+460+595 nm) with arbitrary intensities as the incident light to illuminate the chirped plasmonic grating 100. Reflection images of resonance patterns were captured by the microscope system 200. A total of 500 spectra with different peaks and intensities and images of their corresponding resonance patterns were obtained. The spectra were used as the targeted outputs (i.e., desired reconstructions) of the training data, while the images were used as the inputs. This was not only used to train the neural network 232, but also to calibrate the spectral response function for a conventional method as used in [3]. Another 100 spectra were obtained with different peaks and intensities beyond the scope of the training data for testing the proposed method and conventional method noted above. Mean square error was used to represent a loss function between the normalized and desired output, and the loss of the training set was used to generate gradients (pure learning). The hyperparameters (for example, number of hidden layers, neurons, and learning rates) were set according to the performance on the validation set. A convolutional neural network with four convolutional layers and two fully connected layers with a total of 600 neurons was selected in this embodiment.

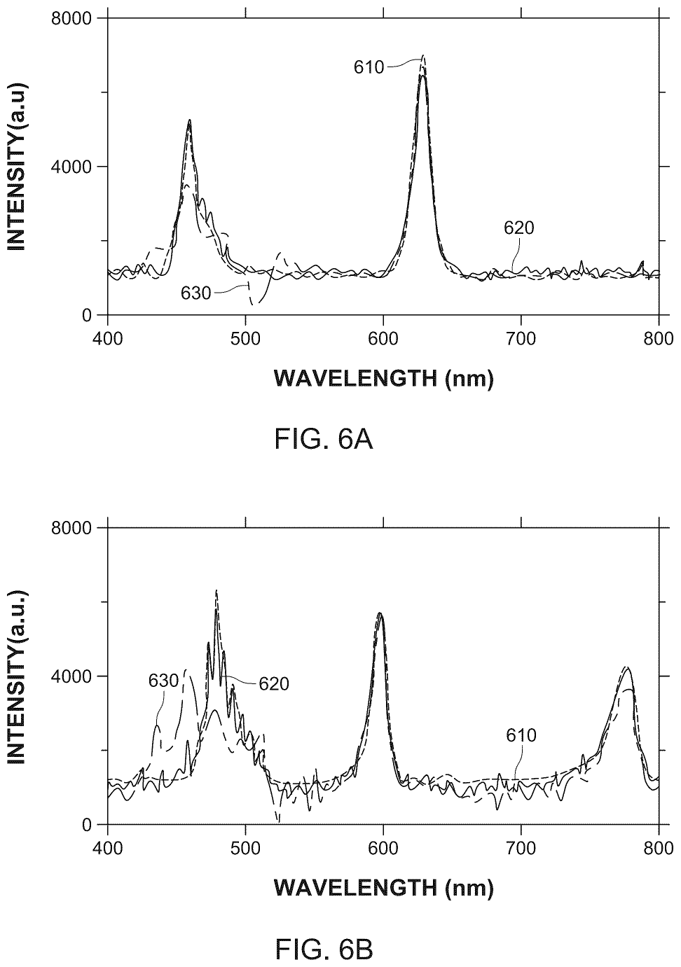

FIGS. 6A and 6B show the results using two sets of testing data (peak wavelengths at 460+635 nm and 470+595+770 nm, respectively) not included in the training process. The dotted line 610 shows the gold standard spectrum of the incident light measured by the conventional grating-based spectrometer. The solid lines 620 are the reconstructed spectra, agreeing very well with the actual spectrum. In contrast, this embodiment also calculated the spectrum using conventional methods based on the same 500 sets of training data and plotted the spectrum by the dashed line 630. One can see that the spectral features near 460 and 470 nm were obviously misinterpreted by the conventional methods. The results demonstrate the proposed intelligent imaging-based spectrometer on a chip is applicable in this scenario.

Reconstruction of arbitrary spectra will require sufficient training data to cover various spectral features of different spectral samples. In particular, one needs to collect combinations of different narrowband and broadband spectra. In one embodiment, the inventor used the LED light source to demonstrate a broadband spectrum reconstruction. This LED light source allows for a combination of multiple LEDs to construct more complicated spectra. As a result, the spectral feature is different from individual LEDs, especially at the overlapped regions among different LED spectra. For the training dataset, the inventor collected individual, double-wavelength and triple-wavelength combinations. After that, the inventor collected four different sets of three-wavelength combinations with different intensities for testing, which were not included in the training datasets. The reconstructed spectra (not shown), when compared with the measured spectra (not shown), shows that the spectral features (especially the feature at the overlapped regime) were well predicted. Thus, the procedure for arbitrary spectrum reconstruction will follow the same approach, but will need more training to include all possible features in the target spectra.

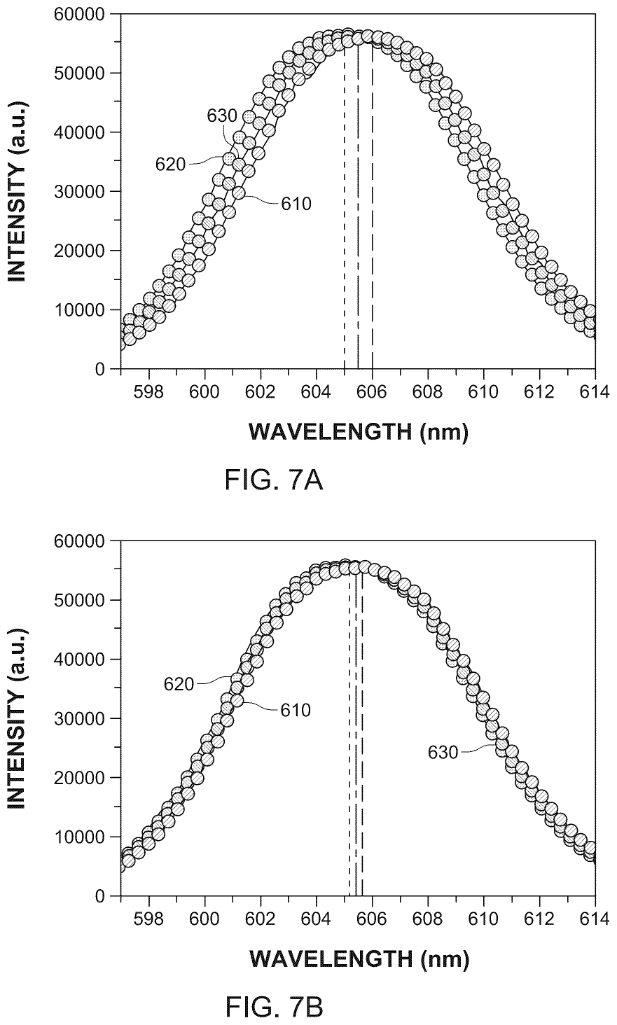

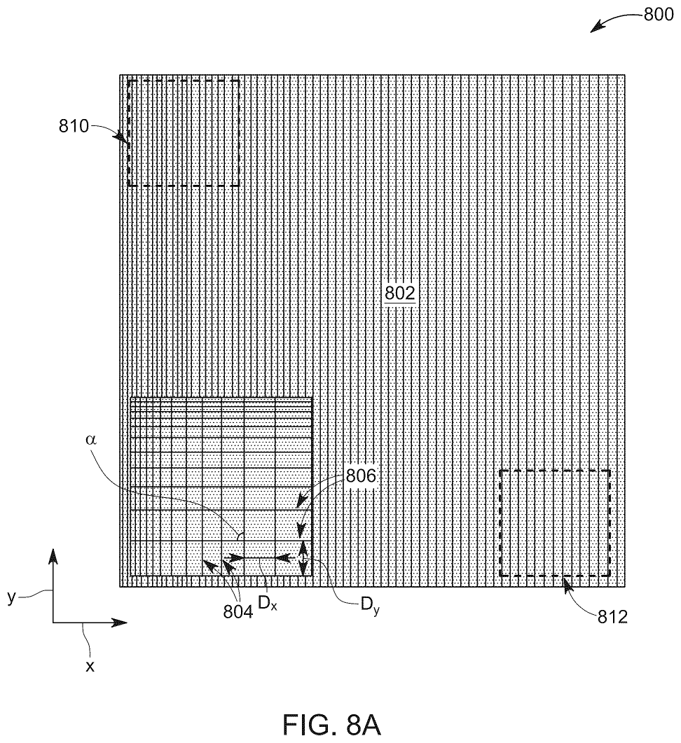

Because spectral resolution is one of the most important parameters to evaluate the performance for conventional spectrometers, the inventor used a broadband halogen lamp through a liquid crystal filter to reveal its resolution in wavelength shift. 10,000 images of the rainbow chip were captured under the illumination of narrowband incidence from 600 to 650 nm with the step size of 0.1 nm tuned by the liquid crystal filter. Their actual spectra were characterized using the fiber-based spectrometer. 8000 (and 9000) images have been selected randomly as training data. After training, the remaining 2000 (and 1000) images, which were not included in the training data, were tested. As shown in FIGS. 7A and 7B, single peaks can be reconstructed and well resolved with the peak shift of 0.5 nm (FIG. 7A) and 0.2 nm (FIG. 7B). The accuracy of the reconstructed peak position is 87-95% for the peak shift of 0.5 nm, and 81-90% for the peak shift of 0.2 nm.

To further reveal the spectral analysis capability, two narrow peaks were introduced, and they are controlled by a programmable acoustic optical filter to illuminate the grating simultaneously. Various representative spectra of the incident narrowband light were plotted (not shown): one peak was fixed at the wavelength of 596.8 nm. The other narrow peak was tuned from 596.8 to 646.8 nm with the step size of 0.1 nm. It was found that these two adjacent incident peaks produced a combined spectrum, showing that the two peaks gradually separate apart with each other and therefore can be resolved by the conventional spectrometer. In this experiment, 901 images were collected as the training set and 100 images for testing. The reconstructed spectra (not shown) agree perfectly with the measured spectra. It was found that the two-peak identification is similar to determining the optical resolution in imaging applications using the Rayleigh criterion. According to the reconstructed and measured spectra, the two-peak feature was clearly resolved when the wavelength difference is beyond 2 nm. This data indicates the potential of using the smart rainbow chip system to perform high-resolution spectral analysis with the equivalent performance compared with conventional spectrometers.

The 1D grating 100 discussed above is now extended into 2D to enable polarimetric spectroscopy using the compact smart system 200, which is superior over conventional optical spectrometer systems. In this regard, polarization is one of the most fundamental properties describing the path traversed by the electric field vector of an optical beam. Polarization-sensitive coloration phenomenon has been observed in many animals' skin, indicating the potential application in biomimetic optical communication. In addition, polarimetric sensing and imaging techniques are widely used in material characterization, remote sensing and imaging, and security and defense applications. For instance, a compact polarimetric imaging system was reported using a large-scale dielectric metasurface component (i.e., 1.5 mm in diameter, see [22]) in the regular imaging system. Multiple polarizer elements and optical coupling elements can therefore be simplified, compactifying the footprint of the entire optical systems relying on conventional polarization optics. Thus, miniaturization and simplification of conventional, bulky, and time-consuming optical characterization could be achieved. The plasmonic rainbow chip spectrometer to be discussed next can introduce a simplified, compact, and intelligent spectro-polarimetric system with accurate and rapid spectral analysis capabilities.

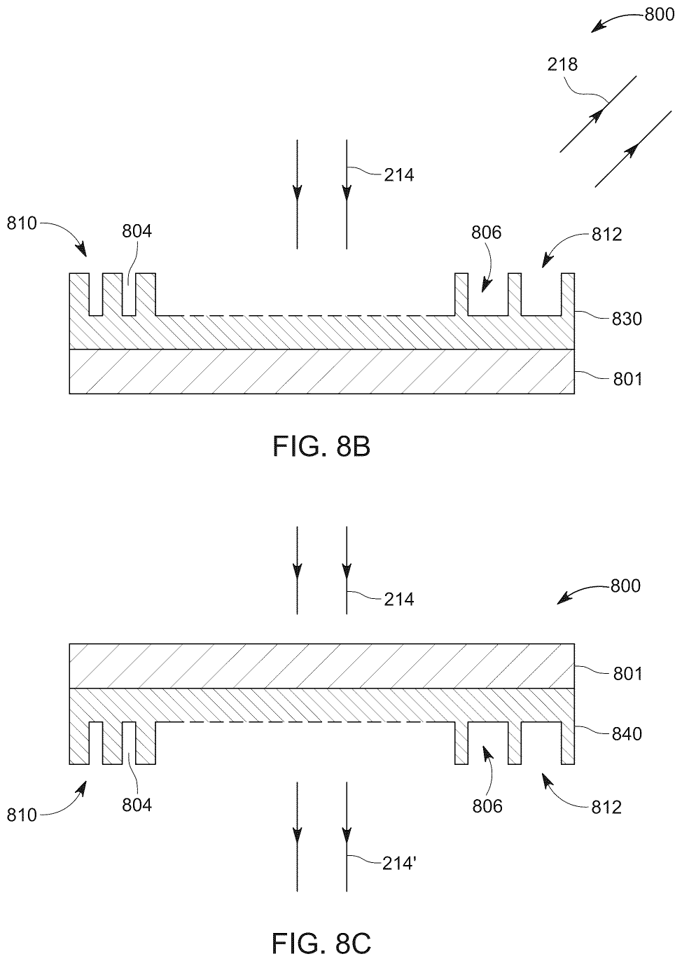

In this regard, FIG. 8A shows one possible 2D plasmonic chip 800 with graded geometric parameters. The 2D grating or plasmonic chip 800 includes a layer of material 802 (for example, a metal like Ag) on which plural first grooves 804 are formed. The first grooves are parallel in this embodiment to the Y axis. The layer of material 802 also has plural second grooves 806, which are arranged to be parallel to the X axis. Thus, the first plural grooves 804 are perpendicular to the second plural grooves 806. However, in one embodiment, the two sets of grooves are about or substantially perpendicular to each other, for example, making an angle α between 80 and 100 degrees.

A distance Dx between the grooves of the first plural grooves 804 and a distance Dy between the grooves of the second plural grooves 806 varies (e.g., increases continuously or in steps) along the X and Y directions, respectively. This means that one corner 810 of the chip 800 has small distances Dx and Dy (e.g., smallest), while an opposite corner 812 has large distances Dx and Dy (e.g., largest). In one application, corner 810 has the smallest values of distances Dx and Dy and corner 812 has the largest values of distances Dx and Dy. In one application, the distances Dx and Dy are equal as they vary along their corresponding axes. However, in another application, these distances may be different from each other. In one application, when the two distances are equal, they may vary from 439 nm in corner 810 to 739 nm in corner 812. These values for the distances Dx and Dy are selected to image a sample using visible light. These distances may be modified depending on the desired sample and/or the desired light spectrum to be analyzed. Note that FIG. 1 showed groups of grooves having the same separation distance D1 to D5. In this embodiment, the distance Dx or Dy may vary continually, i.e., there are not two pairs of grooves along the X or Y direction that have the same separation distance. However, in one embodiment, the chip 800 may be structured as the chip 100, i.e., groups of grooves may share the same separation distance.

In one application, the first plural grooves are split in groups (for example, groups of 2 to 8 grooves), and each group has a unique distance Dx associated with it, and that distance increases from one group to the next group along the axis X. The distance may increase continuously or in steps. The continuous increase may be linear, exponential, or follow other functions. The same is true for the second plural grooves. However, in another embodiment, each group is made to include a single groove, which means that a distance Dx between adjacent grooves changes continuously or in steps, for any two adjacent grooves, from a first initial value to a second final value. The same is true for the second plural grooves having the distance Dy, i.e., changes from a third value to a fourth value. In one application, the first and third values are the same and the second and fourth values are the same. As noted above, the two distances Dx and Dy may increase in step or out of step. A step of change for the distances Dx and Dy, from one groove to the next one or from one group to the next one may be between 1 and 30 nm when the increase is discrete (i.e., non-continuous).

A method for making the chip 800 is now discussed. The method may start with deposition of a 300 nm-thick Ag film 830 on a glass slide 801 via electron beam evaporation, as shown in FIG. 8B. Focus ion beam (FIB) milling may be used to etch the grooves 804 and 806 (graded grating patterns) into the Ag film 830. The period of the gratings may vary, in one embodiment, from 244 nm to 764 nm, either continuously or discrete, for example with a 10 nm step. Other values for the distances Dx and Dy may be selected depending on the target sample and the desired spectrum to be generated and analyzed. Note that the dash line in FIGS. 8B and 8C indicate the continuous variation of the period between the gratings, which means that plural gratings are present there, but not shown. A depth of the grooves may be up to 50 nm, with a preferred value of about 20 nm. As the Ag film 830 is not transparent for the light, the chip 800 is used in the reflection mode, i.e., incident light 214 on the grooves is reflected and then an image of the reflected light 218 is generated. However, it is possible to use a semi-transparent metal film 840, as illustrated in FIG. 8C, and then the transmitted light 214′ is used for imagining (thus, the chip 800 is used in a transmission mode herein). Note that the grooves 804 and 806 formed into the film 840 may have the same configuration (geometry, distances) as the chip 800 shown in FIG. 8B. Thus, for this embodiment, the chip 800 is used in the transmission mode.

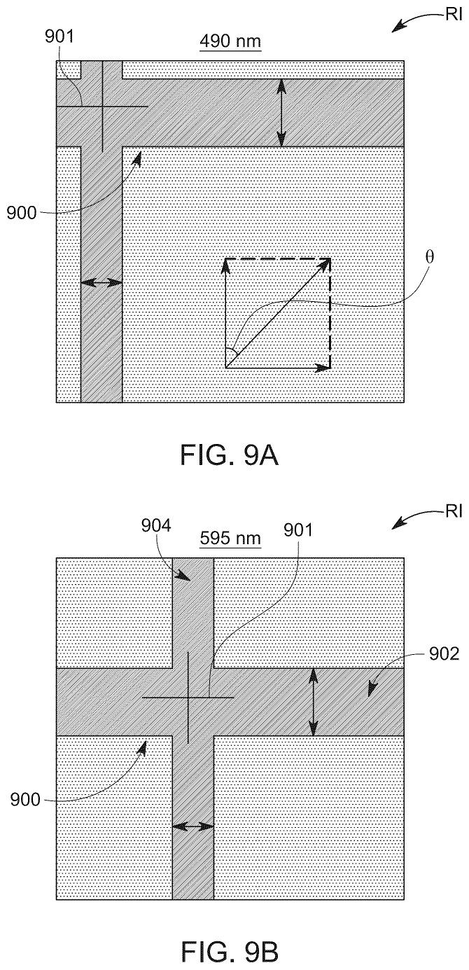

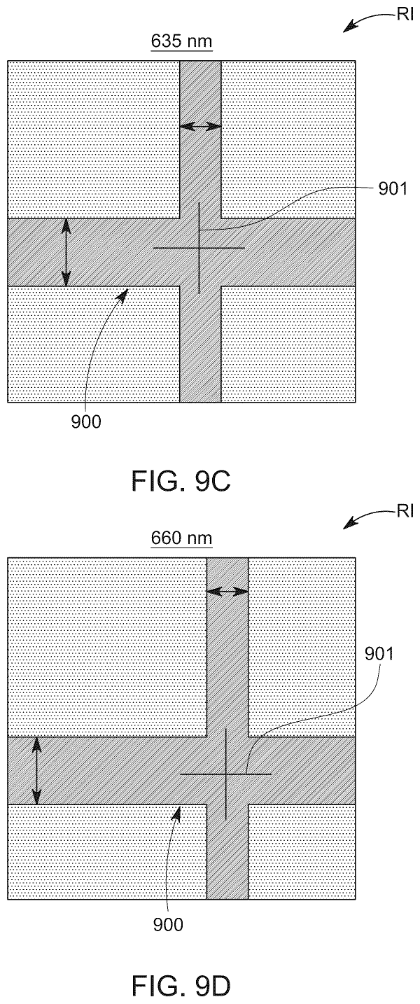

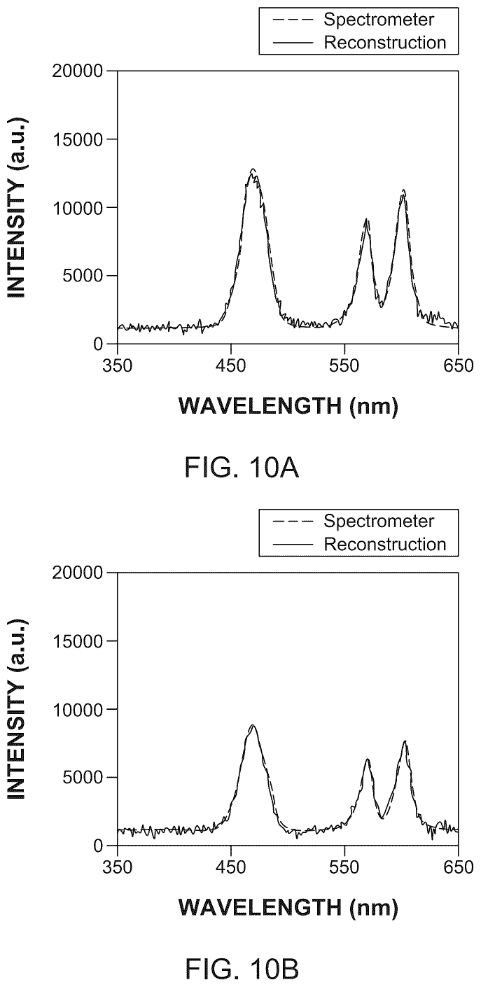

By capturing the reflection image of this 2D chirped grating 800, one can see a “cross” bar 900 with two arms 902 and 904, representing two polarization states (see reflection images RI at four different wavelengths in FIGS. 9A to 9D). The intersection position 901 of the cross bar 900 corresponds to the peak position of the incident wavelength, and the intensities of the two arms 902 and 904 represent the component intensities of the two polarization states along the horizontal and vertical directions, respectively. Following a similar data training process as the one used with regard to FIG. 5, and using different combined LED lights, an intelligent polarimetric spectrometer is demonstrated. FIGS. 10A and 10B show the reconstructed spectra using two sets of testing data (two different polarized light with peak wavelengths at 490, 595, and 635 nm, respectively) not included in the training process. It is noted that the reconstructed spectra agree very well with the measured spectra so that it is difficult to distinguish the two curves in these figures. Thus, this unique intelligent spectrometer chip 800 can enable rapid polarimetric spectroscopy sensing applications, as discussed next.

ORD characterization of a sample, with the chip 800 used in the system 200, is now discussed. Conventional ORD systems measure the optical rotation introduced by a substance as a function of the incident wavelength. To perform an accurate characterization, special facilities are usually required with multiple polarization generators and analyzers (i.e., so-called polarimetry systems). By scanning the illumination spectrum and comparing its output polarization state to its initial polarization state, one can obtain the ORD of the sample. The accuracy in determining the ORD depends on the polarizer tuning resolution. Manually tuned polarizers require fine rotation to get the complete spatial distribution for a single wavelength, which is tedious and time-consuming. They are also inaccurate due to errors introduced during measurement (e.g., parallax error). Faster and more accurate measurement is achievable using electronically tuned polarizers. However, these polarizers are costly and require periodic recalibration to maintain their optimal performance.

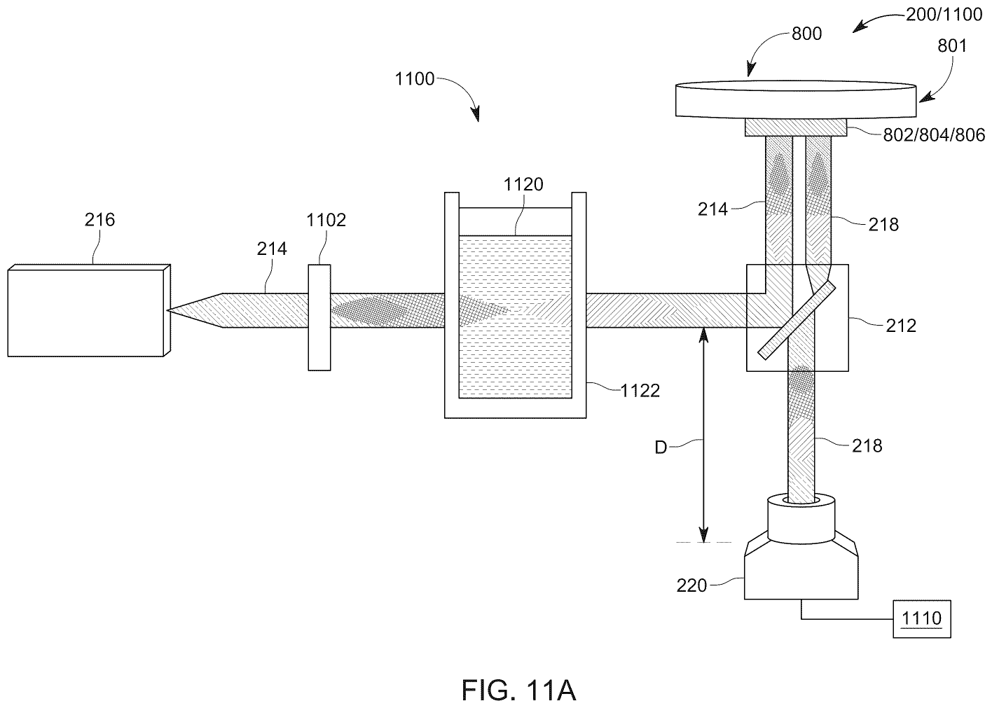

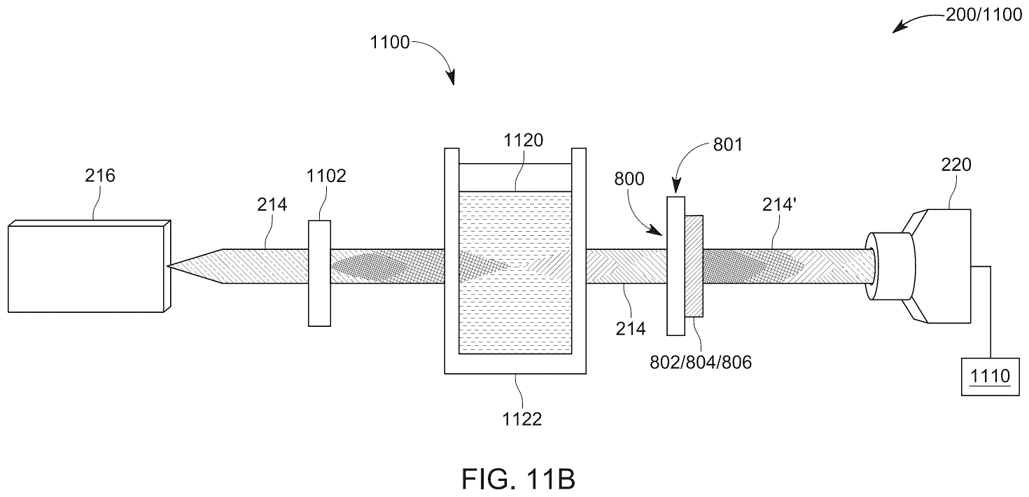

In contrast, the novel imager-based system 200 using the chip 800 can provide broadband spectral information and polarization distribution from a single image. Therefore, the time-consuming spatial rotation and wavelength scanning processes can be significantly reduced in the 2D imaging characterization. In one experiment, the system 200 using the chip 800 was used as a spectro-polarimetric system for glucose sensing applications. For conventional spectro-polarimetric characterization, it is desired that the system is able to accurately measure the ORD of a light sample across a broad spectral range. In addition to the issues discussed above with regard to the existing systems, the conventional systems further require tunable narrowband illumination sources to measure the optical rotation for one spectral peak at a time. However, this approach is further time-consuming and adds to the large amount of tuning already required by the polarizers. Moreover, this traditional approach adds further constraints to the system, as its spectral resolution and operating range become dependent on the tunability of the narrowband illumination source. The novel imager-based system 200, which is implemented as system 1100 in FIG. 11A (in the reflection mode) or in FIG. 11B (in the transmission mode), enables the optical rotation measurement under the illumination of multiple spectral peaks at once, by training the DL algorithm with images of the graded grating under illumination with multiple peaks. Such capability would allow for more thorough and efficient analysis as well as the use of broadband illumination sources.

The imager-based setup 200, which is shown in FIGS. 11A and 11B as system 1100, includes a polarizer 1102 for fixing the polarization state of the incident light 214. The traditional analyzer is replaced for the embodiment of FIG. 11A with the beam splitter 212, which is optically located between the plasmonic grating chip 800 and detector 220 (for example, a camera), to observe the reflection mode (reflected light 218) of the chip 800. For the embodiment of FIG. 11B, the traditional analyzer is simply omitted. The chip 800 shown in FIG. 11B may be placed as shown in the figure (i.e., with the gratings facing the detector 220), or rotated by 180 degrees, i.e., with the gratings facing the incoming light beam 214. For the light source 216, a fiber-coupled cool LED was used in this embodiment. Those skilled in the art would understand that other light sources may be used. A grayscale camera 220 attached to an optical microscope 1110 is used to observe the cross-bar patterns 900 on the chip 800. In one application, a distance D in FIG. 11A, between the beam splitter 212 and the light detector 220 is about 1 to 2 cm, and a thickness of the plasmonic chip 800 is about 200 μm or less. In one application, the chip 800 is made of a substrate 801, for example, glass or quartz. The material 802 (which corresponds to the layers 830 or 840 in FIGS. 8B and 8C) may include a first layer of Ag or Au on which a Cr layer is formed. The grooves 804 and 806 are formed in the Ag, Au, or Cr layer. The sample 1120 to be analyzed, which may be a liquid, is placed in a transparent container 1122, which is optically located between the polarizer 1102 and the splitter 212.

For the DL reconstruction, the training data consisted of 26,100 images of the graded grating under various illumination conditions. This system captured a wide variety of cross-bar 900 resonance patterns (not shown). Air and deionized (DI) water were used as the samples 1120 for capturing the training data. The trained DL model was then tested using 540 images of the chip under similar illumination conditions. Testing images were captured using aqueous glucose solutions of 2, 10, and 30%. Under the same incident polarization, light-matter interactions with glucose will result in a different output polarization of the illumination spectrum than those with air or water. Due to the wavelength-dependent spatial distribution of the cross-bar patterns 900 on the grating 800, multiple patterns can be created for each peak in the illumination spectra at once. The DL application 232 can then predict the spectral peaks and their respective polarization states, corresponding to each pattern.

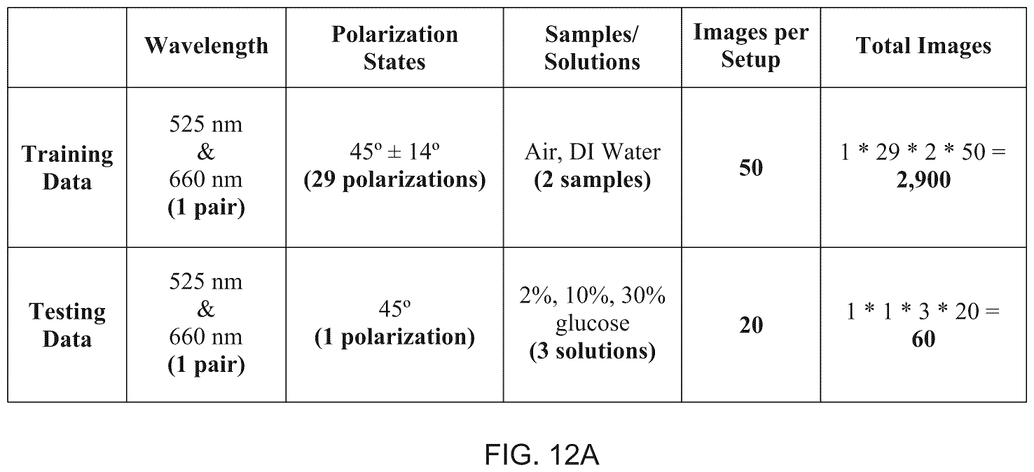

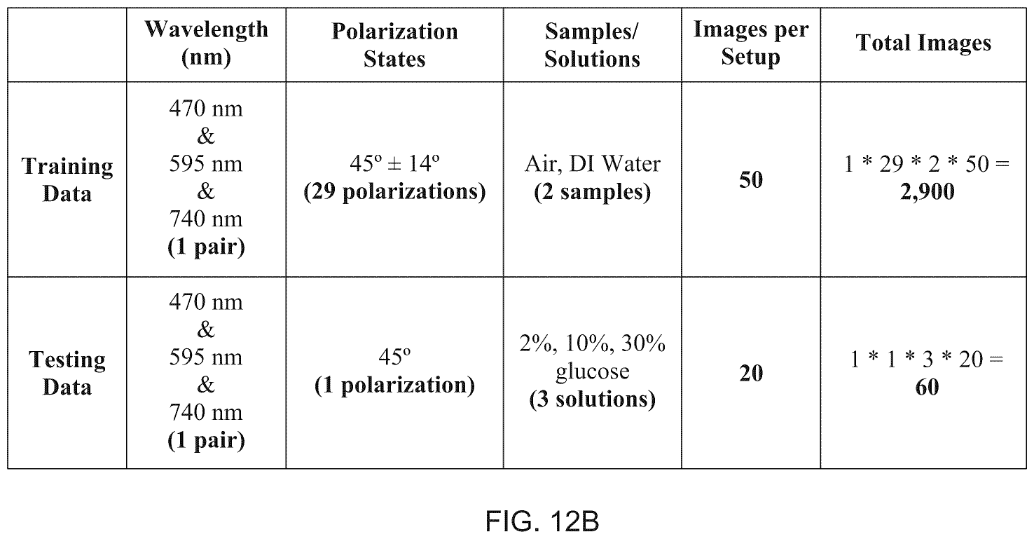

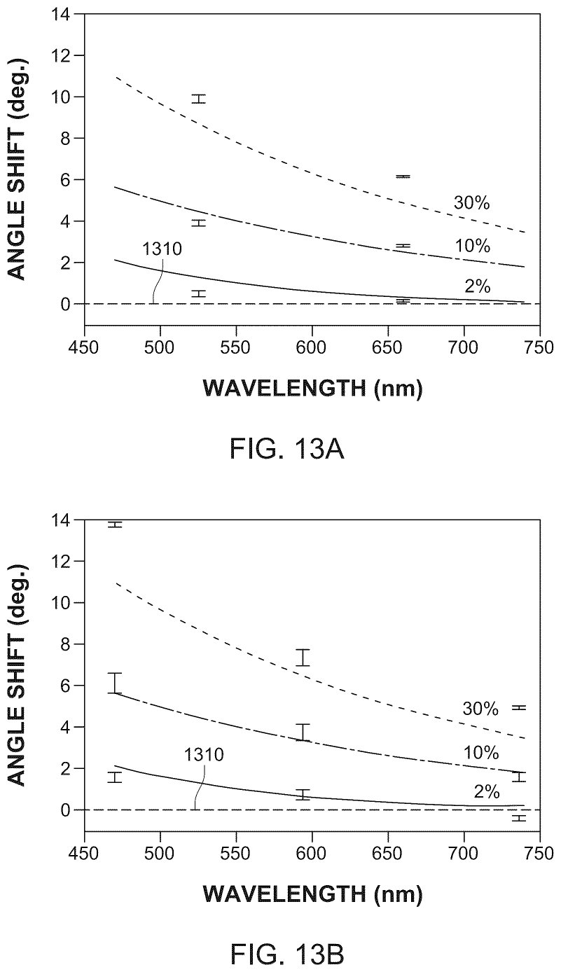

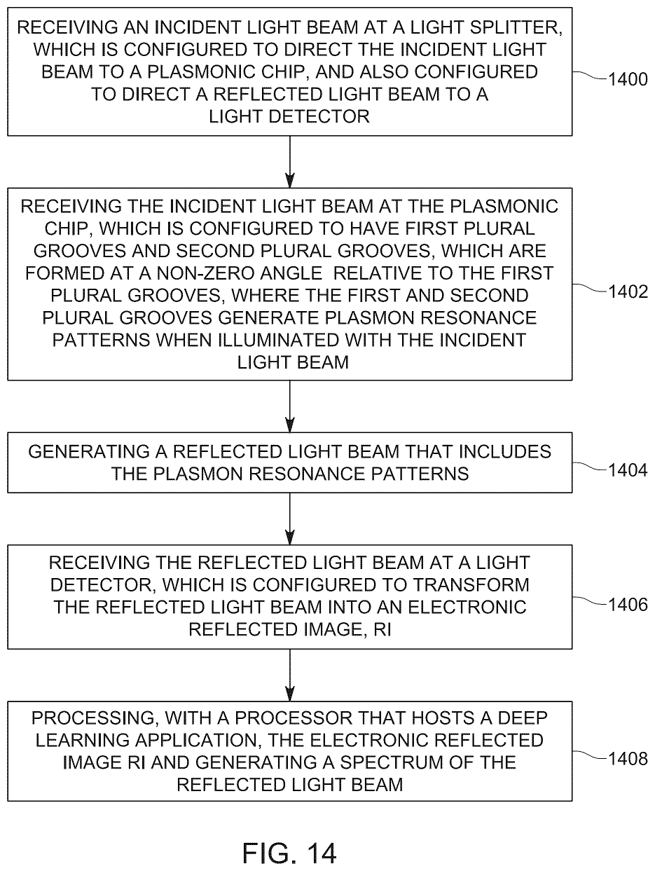

To show the multi-spectral sensing capabilities of the imager-based system 200/1100, an additional set of training and testing data was collected under double-peak and triple-peak illumination. The data parameters associated with the training and testing data are shown in tables of FIGS. 12A and 12B. Various images (not shown) of the chip under both of these conditions are obtained. To make the spectral peaks as individually noticeable as possible, the inventor selected 525 and 660 nm for the double-peak illumination and 470, 595, and 740 nm for the triple-peak illumination. FIGS. 13A and 13B plot the double-peak and triple-peak predictions, respectively, of the DL model for 2, 10, and 30% aqueous glucose solutions. The deviations of reconstructed polarization angles (50 data at each wavelength) range from 0.07° to 0.45°. It was found that the predictions made for both illumination conditions agree well with their respective ORD curves, indicating that the DL algorithm was able to predict the optical rotation introduced by each of the glucose solutions. Moreover, not only did the algorithm identify the peaks of the illumination spectrum, it also isolated them to analyze their unique polarization states despite them all being fixed to the same incident polarization.

In contrast, pure water solution (i.e., 0%, see curve 1310) did not introduce any rotation. As such, the imager-based system 200/1100 can simultaneously perform rapid spectroscopic and polarimetric analysis of chiral samples, which is essential for on-site, real-time, and point-of-care applications. It should be noted that in this analysis, only 29 different angles with a step size of 1.0° were collected as the training data used a manually tuned polarizer. Due to this limited training dataset, the reconstructed ORD shows inconsistency with the measured curves. This limitation can be improved using finely tuned electronic-driven polarizers to produce training datasets for future studies.

While the system 200/1100 discussed above was used in the context of a light detector 220, which may be part of a microscope 1110, one skilled in the art would understand that the plasmonic chip 800 may be used with a portable device having a camera, for example, a smart phone or a smart device. Also note that the 1D and 2D chips 100 and 800 are configured to exhibit resonance patterns caused by the surface plasmon coupling of light. Due to the nonuniform spatial and intensity distributions of the grating patterns, different resonance patterns could be observed depending on the spectral peaks and polarization state of incident light (i.e., the dark bar and dark cross-bar patterns on the 1D and 2D gratings, respectively). By exploiting these features of the graded gratings, information about the illumination spectrum can be extracted from the observation of the on-chip resonance pattern.

The DL application 232 was integrated into the proposed spectrometer system 200/1100 to automatically make these observations. By training the algorithm with images of various resonance patterns and the lineshapes of their corresponding illumination spectra, spectroscopic analysis was realized. Meanwhile, polarimetric analysis was achieved by training the algorithm with images of resonance patterns under a broad range of polarization states. The results discussed above show that spectral reconstructions performed by the proposed spectrometer agree well with the spectra measured by a conventional benchtop spectrometer, demonstrating the capability of the proposed system to perform accurate spectroscopic analysis. Spectroscopic analysis was also performed for horizontally and vertically polarized illumination, demonstrating the capabilities of the proposed system in reconstructing the illumination spectra and distinguishing them between both polarization states. Analysis performed by the DL application show that the proposed system is further capable of accurate and timely polarimetric analysis based on the intensities of the cross bars of the 2D grating resonance patterns. Most notably, both spectroscopic and polarimetric analyses are made possible by the proposed system using a single image of the plasmonic platform. Moreover, DL predictions of the ORD introduced by various glucose solutions indicate the capabilities of the proposed system to perform accurate detection and quantification of chiral substances. The image-based design of the proposed spectrometer system removes the need for optical elements, as well as wavelength scanning and rotating processes. The image-based spectrometer 200/1100 achieves the realization of high-performance spectro-polarimetric analysis in a single compact and lightweight design, giving it significant potential for use of deep optics and photonics in healthcare monitoring, food safety sensing, environmental pollution detection, drug abuse sensing and forensic analysis.

A method for determining a spectrum and polarization of a light with the chip 100/800 is now being discussed. The method includes an optional step 1400 of receiving an incident light beam at a light splitter, which is configured to direct the incident light beam to a plasmonic chip, and also configured to direct a reflected light beam to a light detector (note that this step is present if the chip is used in the reflection mode, not in the transmission mode), a step 1402 of receiving the incident light beam at the plasmonic chip, which is configured to have first plural grooves and second plural grooves, which are formed at a non-zero angle relative to the first plural grooves, where the first and second plural grooves generate plasmon resonance patterns when illuminated with the incident light beam, a step 1404 of generating a transmitted light beam (in the transmitting mode shown in FIG. 11B) or a reflected light beam (in the reflecting mode shown in FIG. 11A) that includes the plasmon resonance patterns, a step 1406 of receiving the transmitted light beam or the reflected light beam at a light detector, which is configured to transform the transmitted light beam or the reflected light beam into an electronic reflected image, RI, and a step 1408 of processing, with a processor that hosts a deep learning application, the electronic reflected image RI and simultaneously generating a spectrum and polarization of the reflected light beam.

In one application, the first plural grooves are separated from each other by a varying distance Dx, where the distance Dx changes from a first value to a second value, which is larger than the first value, and where the second plural grooves are separated from each other by a varying distance Dy, where the distance Dy changes from a third value to a fourth value, which is larger than the third value. In this or another application, the distance Dx is different for any two adjacent grooves of the first plural grooves and the distance Dy is different for any two adjacent grooves of the second plural grooves.

The term “about” is used in this application to mean a variation of up to 20% of the parameter characterized by this term.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a spectrometer on a chip system with qualities comparable to the benchtop spectrometers. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Yang, Z., Albrow-Owen, T., Cai, W. & Hasan, T. Miniaturization of optical spectrometers. Science 371, 480 (2021).
[2] Bao, J. & Bawendi, M. G. A colloidal quantum dot spectrometer. Nature 523, 67-70 (2015).
[3] Yang, Z. et al. Single-nanowire spectrometers. Science 365, 1017-1020 (2019).
[4] Wang, Z. et al. Single-shot on-chip spectral sensors based on photonic crystal slabs. Nature Communications 10, 1020-1020 (2019).
[5] Yokogawa, S., Burgos, S. P. & Atwater, H. A. Plasmonic Color Filters for CMOS Image Sensor Applications. Nano Letters 12, 4349-4354 (2012).
[6] Smalley, J. S. T. et al. Subwavelength pixelated CMOS color sensors based on anti-Hermitian metasurface. Nature Communications 11, 3916-3916 (2020).
[7] Jahani, Y. et al. Imaging-based spectrometer-less optofluidic biosensors based on dielectric metasurfaces for detecting extracellular vesicles. Nature Communications 12, 3246-3246 (2021).
[8] Wu, W., Yu, Y., Liu, W. & Zhang, X. Fully integrated CMOS-compatible polarization analyzer. Nanophotonics 8, 467-474 (2019).
[9] Kim, C., Lee, W. B., Lee, S. K., Lee, Y. T. & Lee, H. N. Fabrication of 2D thin-film filter-array for compressive sensing spectroscopy. Optics and Lasers in Engineering 115, 53-58 (2019).
[10] Wetzstein, G. et al. Inference in artificial intelligence with deep optics and photonics. Nature 588, 39-47 (2020).
[11] Lin, X. et al. All-optical machine learning using diffractive deep neural networks. Science 361, 1004-1008 (2018).
[12] Zuo, C. et al. Deep learning in optical metrology: a review. Light: Science & Applications 11, 39-39 (2022).
[13] Yao, K., Unni, R. & Zheng, Y. Intelligent Nanophotonics: Merging Photonics and Artificial Intelligence at the Nanoscale. Nanophotonics 8, 339-366 (2019).
[14] Brown, C. et al. Neural Network-Based On-Chip Spectroscopy Using a Scalable Plasmonic Encoder. ACS Nano 15, 6305-6315 (2021).
[15] Fang, L. et al. Deep learning-based point-scanning super-resolution imaging. Nature Methods 18, 406-416 (2021).
[16] Lin, X. et al. High Throughput Blood Analysis Based on Deep Learning Algorithm and Self-Positioning Super-Hydrophobic SERS Platform for Non-Invasive Multi-Disease Screening. Advanced Functional Materials 31, 2103382-n/a (2021).
[17] Gao, D. et al. A deep learning approach to identify gene targets of a therapeutic for human splicing disorders. Nature Communications 12, 3332-3332 (2021).
[18] Kita, D. M. et al. High-performance and scalable on-chip digital Fourier transform spectroscopy. Nature Communications 9, 4405-4407 (2018).
[19] Malkiel, I. et al. Plasmonic nanostructure design and characterization via Deep Learning. Light: Science & Applications 7, 60-68 (2018).
[20] Shastri, B. J. et al. Photonics for artificial intelligence and neuromorphic computing. Nature Photonics 15, 102-114 (2021).
[21] Cadusch Jasper, J., Meng, J., Craig Benjamin, J., Shrestha Vivek, R. & Crozier Kenneth, B. Visible to long-wave infrared chip-scale spectrometers based on photodetectors with tailored responsivities and multispectral filters. Nanophotonics 9, 3197-3208 (2020).
[22] Rubin, N. A. et al. Matrix Fourier optics enables a compact full-Stokes polarization camera. Science 365, 43 (2019).

1. A spectrometer on a chip system comprising:
a plasmonic chip configured to have first plural grooves and second plural grooves, formed at a non-zero angle relative to the first plural grooves, wherein the first and second plural grooves generate plasmon resonance patterns when illuminated with an incident light beam;
a light detector configured to receive a transmitted light beam or a reflected light beam, and to transform the transmitted light beam or the reflected light beam into an electronic reflected image, RI; and
a processor that hosts a deep learning application configured to receive the electronic reflected image RI and generate a spectrum of the reflected light.

2. The system of claim 1, wherein the plasmonic chip is made in a layer of metal.

3. The system of claim 1, wherein the angle is about 90 degrees and the layer of metal is transparent to the incident light beam.

4. The system of claim 1, wherein the first plural grooves are separated from each other by a varying distance Dx, wherein the distance Dx changes from a first initial value to a second final value, which is larger than the first initial value, and wherein the second plural grooves are separated from each other by a varying distance Dy, wherein the distance Dy changes from a third initial value to a fourth final value, which is larger than the third initial value.

5. The system of claim 4, wherein the first initial value is equal to the third initial value and the second final value is equal to the fourth final value, and Dx is equal to Dy for any two adjacent grooves.

6. The system of claim 4, wherein the distance Dx is different for any two adjacent grooves of the first plural grooves and the distance Dy is different for any two adjacent grooves of the second plural grooves.

7. The system of claim 6, wherein Dx is equal to Dy.

8. The system of claim 4, wherein the first plural grooves form plural first groups, each first group having a number of grooves equal to or larger than 2, and the distance Dx is the same for any given first group, but changes from one first group to another first group, and wherein the second plural grooves form plural second groups, each second group having a number of grooves equal to or larger than 2, and the distance Dy is the same for any given second group, but changes from one second group to another second group.

9. The system of claim 8, wherein Dx is equal to Dy.

10. The system of claim 1, wherein the plasmonic chip generates the transmitted light beam or the reflected light beam to include patterns having a cross bar with two arms representing two polarization states.

11. The system of claim 1, wherein there is no moving polarizer.

12. A plasmonic chip comprising:
a layer of metal having,
first plural grooves, and
second plural grooves, formed at a non-zero angle relative to the first plural grooves,
wherein the first and second plural grooves generate plasmon resonance patterns when illuminated with an incident light beam.

13. The chip of claim 12, wherein the angle is about 90 degrees and the layer of metal is transparent to the incident light beam.

14. The chip of claim 12, wherein the first plural grooves are separated from each other by a varying distance Dx, wherein the distance Dx changes from a first initial value to a second final value, which is larger than the first initial value, and wherein the second plural grooves are separated from each other by a varying distance Dy, wherein the distance Dy changes from a third initial value to a fourth final value, which is larger than the third initial value.

15. The chip of claim 14, wherein the distance Dx is different for any two adjacent grooves of the first plural grooves and the distance Dy is different for any two adjacent grooves of the second plural grooves.

16. The chip of claim 14, wherein the first plural grooves form plural first groups, each first group having a number of grooves equal to or larger than 2, and the distance Dx is the same for any given first group, but changes from one first group to another first group, and wherein the second plural grooves form plural second groups, each second group having a number of grooves equal to or larger than 2, and the distance Dy is the same for any given second group, but changes from one second group to another second group.

17. The chip of claim 12, wherein the plasmonic chip generates the transmitted light beam or the reflected light beam to include patterns having a cross bar with two arms representing two polarization states.

18. A method for determining a spectrum and polarization of a light, the method comprising:
receiving an incident light beam at a plasmonic chip, which is configured to have first plural grooves and second plural grooves, which are formed at a non-zero angle relative to the first plural grooves, wherein the first and second plural grooves generate plasmon resonance patterns when illuminated with the incident light beam;
generating a transmitted light beam or a reflected light beam that includes the plasmon resonance patterns;
receiving the transmitted light beam or the reflected light beam at a light detector, which is configured to transform the transmitted light beam or the reflected light beam into an electronic reflected image, RI; and
processing, with a processor that hosts a deep learning application, the electronic reflected image RI and simultaneously generating a spectrum of the reflected light beam and associated polarization.

19. The method of claim 18, wherein the first plural grooves are separated from each other by a varying distance Dx, wherein the distance Dx changes from a first value to a second value, which is larger than the first value, and wherein the second plural grooves are separated from each other by a varying distance Dy, wherein the distance Dy changes from a third value to a fourth value, which is larger than the third value.

20. The method of claim 19, wherein the distance Dx is different for any two adjacent grooves of the first plural grooves and the distance Dy is different for any two adjacent grooves of the second plural grooves.
